(19) United States
(12) Patent Application Publication
(10) Pub. No.: US 2005/0115356 A1
(43) Pub. Date: Jun. 2, 2005

(54) Brake flush accelerator

(76) Inventor: Jon A. Petty, Lon, UT (US)

Correspondence Address: QUARLES & BRADY STREICH LANG, LLP, ONE SOUTH CHURCH AVENUE, SUITE 1700, TUCSON, AZ, 85701-1621, US

(21) Appl. No.: 10/981,060

(22) Filed: Nov. 4, 2004

Related U.S. Application Data
(60) Provisional application No. 60/517,296, filed on Nov. 4, 2003.

(51) Int. Cl. G05G 1/16

(52) U.S. Cl. 74/562

(57) ABSTRACT

A Brake Flush Accelerator (“BFA”) automatically depresses a brake pedal while the master cylinder reservoir is under pressure from a brake flush machine, forcing fluid through the system at a very rapid rate. The BFA also provides a thorough flush as internal hydraulic pressure from the master cylinder can be used to exert force to remove contaminates from the brake system. Additionally, the BFA exposes the low/no pressure area of the master cylinder to fluid flow from the pressurized master cylinder. When the brake pedal is depressed, a port in the master cylinder is opened which exposes the low/no pressure area of the master cylinder to fluid flow from the pressurized master cylinder reservoir. This flushes the normally isolated portion of the master cylinder and prevents future contamination. Problems of traditional foot type bleeding or flushing are reduced by accurately controlling the piston stroke and rate of pedal depression and release. The BFA receives its pneumatic power from an air compressor or is easily adapted to a car tire. The BFA system can be powered directly from the brake flush machine or easily attached to a vehicle's battery.

### RELATED APPLICATIONS

This application is based on U.S. provisional Application Ser. No. 60/517,296, filed Nov. 4, 2003.

### BACKGROUND OF THE INVENTION

1. Field of the Invention

Phoenix Systems has developed a Brake Flush Accelerator Module to accompany the new brake flush machines that have begun to enter the automotive service industry. The problem with current brake flush machine technology is that it cannot move fluid through the system with enough force to remove contamination. Removal of this contamination is required to perform a proper flush to meet proposed guidelines for brake fluid replacement and system flush.

2. Description of the Related Art

Anti-lock brake system (ABS) design utilizes multiple hydraulic passage ways and valving that restricts fluid movement. This means that flow through the system will be limited and may take excessive time to properly flush the system. The pressure that can be exerted on the system is limited by the master cylinder reservoir adapter. The adapter connects the pressurized fluid from the brake flush machine to the master cylinder reservoir to the brake system. Most reservoirs are a composite or plastic material and cannot be exposed to pressures above 20 psi without deforming the shape of the reservoir causing leakage. Most brake flush machines limit master cylinder reservoir pressure to 12-18 psi to prevent leakage. The low pressure also makes removing brake fluid contamination more difficult.

In addition, the fluid does not move through each wheel system equally, but it will take the path of least resistance. Some brake flush machines flush all the wheels at the same time, while more advanced machines control flow through the wheels. A machine designed to flush all the wheels at the same time will experience an unequal system flush. This means that one part of the system may experience minimal fluid flow, which will not provide a proper flush.

Advanced brake flush machines, hereafter referred to as isolated flush machines, isolate different parts of the system to control fluid flow. This allows the machine to force fluid though the more restrictive circuits. The downside is that the flush time is lengthened because the flow is isolated to a part of the system and not all the wheels at the same time. A properly isolated flush could take 2-3 times longer to move the same amount of fluid as an all-wheel flush, keeping in mind that the all-wheel flush also experiences an unequal system flush.

Empirical testing using Strip Dips brake fluid test strips has shown that it takes approximately 1/2 gallon of brake fluid flushed through the system at sufficient pressure and flow to attain a proper flush to remove contaminants. Most all wheel flush machines use ½ gallon fluid container and operate for 10-12 minutes. The last minute or two of the cycle removes whatever fluid is left in the container and dumps it into the waste container so that the service uses ½ gallon of brake fluid each time. This does not mean the ½ gallon of brake fluid was flushed through the system, but only that ½ gallon of brake fluid was consumed. The actual flush may have used 1 quart of fresh fluid and the other quart was dumped into the waste. The reason this is done is to complete the flush within the allotted time period and consume ½ gallon of brake fluid per service regardless of the quality of flush.

There is also a low/no pressure area in many master cylinder designs that is isolated from the normal fluid pathway during a flush. This leaves an area of old fluid that can contaminate the new brake fluid after the flush has been performed. Even if ½ gallon of brake fluid is flushed through the system, the isolated low pressure area can contaminate the brake fluid once the brake pedal is depressed a few times. Depressing the brake pedal exposes the new fluid to the low pressure area, which promotes intermixing. This has been demonstrated again by the use of FASCAR® Strip Dip brake fluid test strips. A candidate vehicle was tested with Strip Dip® demonstrating a FASCAR® rating of 100. The brake flush was performed using ½ gallon of brake fluid and the brake fluid was immediately tested after the service, which results in a FASCAR® rating of 0. The vehicle is then driven in which the brake pedal is depressed several times and a Strip Dip® retest is performed, which results in a FASCAR® rating of 25. It is not a problem with the test strip, but the low/no pressure area was not cleaned during the flush process and the old fluid contaminated the rest of the system.

To attain a proper brake system flush, approximately 1/2 gallon of brake fluid must be flushed through the system at sufficient pressure and flow to remove contaminates. In addition, the low/no pressure area of the master cylinder must be exposed to fluid flow to flush that portion of the system to prevent future contamination. An isolated brake flush machine could take as long as 30 minutes to properly introduce ½ gallon of brake fluid through the system, while current all wheel flush machines operate for 10-12 minutes and waste the unused fluid. Each brake flush machine design has severe design flaws, first is the time to perform service or, second, the quality of the service performed.

### BRIEF SUMMARY OF THE INVENTION

The Brake Flush Accelerator (“BFA”) described herein solves the problems current brake flush machines exhibit in attaining a proper brake system flush. The BFA significantly reduces the flush time for any brake flush machine, increases fluid volume and pressure to remove contaminants and allows the low/no pressure area of the master cylinder to be flushed. The BFA also solves the problems of traditional foot type bleeding or flushing by accurately controlling the piston stroke and rate of pedal depression and release. It can be designed as a self-contained module or designed to coexist within the control system in a brake flush machine. It receives its pneumatic power from an air compressor or is easily adapted to a car tire. The system can be powered directly by the brake flush machine or easily attached to vehicle battery power through the cigarette lighter.

Various other purposes and advantages of the invention will become clear from its description in the specification that follows and from the novel features particularly pointed out in the appended claims. Therefore, to the accomplishment of the objectives described above, this invention consists of the features hereinafter illustrated in the drawings, fully described in the detailed description of the preferred embodiment and particularly pointed out in the claims. However, such drawings and description disclose only some of the various ways in which the invention may be practiced.

### BRIEF DESCRIPTION OF THE DRAWINGS

FIG. 1 is a perspective view of the BFA of the invention.

FIG. 2 is a block diagram showing the functions of the BFA of the invention.

### DESCRIPTION OF THE PREFERRED EMBODIMENTS OF THE INVENTION

Phoenix Systems has developed a Brake Flush Accelerator Module to be used in conjunction with existing brake flush machines. The invention eliminates the problems with current flush technology and can be used to significantly improve the brake system flush for most any type of brake flushing machine.

The Brake Flush Accelerator Module (BFA) automatically depresses the brake pedal while the master cylinder reservoir is under pressure from the brake flush machine. This accomplished two main functions. First, the BFA can force fluid through the system at a very rapid rate. Testing has shown that the BFA can pump ½ gallon of brake fluid through the brake system as much as five times faster then standard brake flush machine. The BFA also provides a much more thorough flush as internal hydraulic pressure from the master cylinder can be used to exert much more force to remove contaminates from the system.

Second, The BFA exposes the low/no pressure area of the master cylinder to fluid flow from the pressurized master cylinder. When the brake pedal is depressed, a port in the master cylinder is opened which exposes the low/no pressure area of the master cylinder to fluid flow from the pressurized master cylinder reservoir. This flushes the normally isolated portion of the master cylinder and prevents future contamination.

The ideal brake flush machine to be used with the BFA is the isolated brake flush machine, which can isolate each wheel or a portion of the system to make sure each circuit is properly flushed. The BFA will also work with an all-wheel brake flush machine to enhance its operation, but an equal system flush cannot be attained because there is no way to isolate portions of the brake system.

In addition, the BFA can control the rate at which the brake pedal is released. By releasing the brake pedal slowly the fluid in the master cylinder can be replenished from the pressurized fluid in the reservoir from the brake flush machine. This prevents the wheels from drawing fluid or air back into the system when the brake pedal is released. If the master cylinder was not under pressure, the master cylinder piston would draw fluid or air back from the open wheel circuits when the brake pedal is released. That is why antiquated brake bleeding required two people, one person to pump the pedal and the other person to open and close the bleeder valve in time with brake pedal depression and release to prevent the system from drawing air. Thus, The BFA solves the problem most commonly associated with foot bleeding or flushing of the hydraulic system.

The BFA control system can be integral with the brake flush machine control system or it can be a stand alone module capable of interfacing with an existing brake flush machine. This makes the unit very marketable to the owner of any brake flush machine as this module can be added to the existing machine to increase its performance.

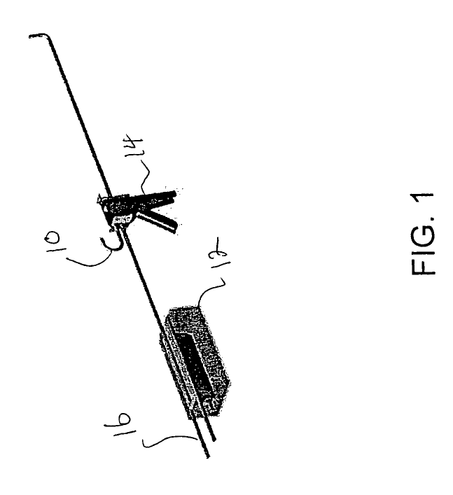

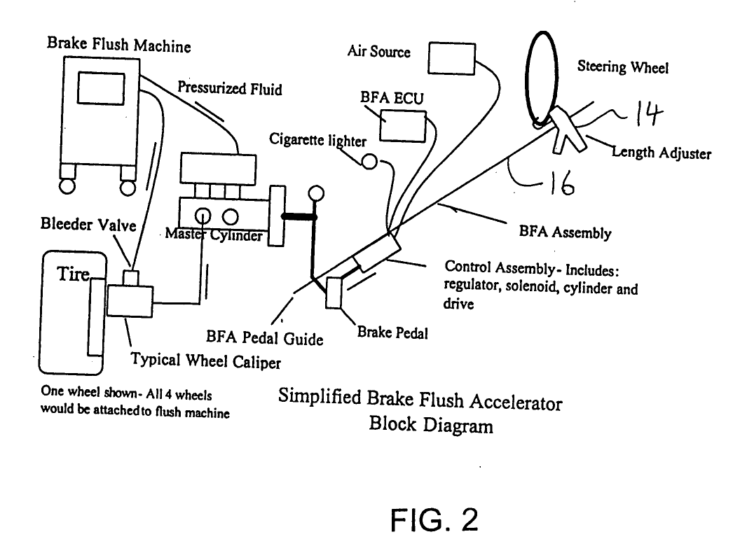

As illustrated in FIGS. 1 and 2, the BFA is uniquely designed so that it can work with any vehicle which has a brake pedal and steering wheel mounted in traditional locations. The upper portion 10 of the unit attaches to the steering wheel and the lower portion 12 rests on the brake pedal. The unit is equipped with a length adjuster 14 to adapt to different brake to steering wheel configurations. A guide 16 keeps the module in constant contact with the brake pedal. A pneumatic piston is operated by air pressure that is modulated by the BFA control system though the air control solenoid. The BFA also has an air pressure regulator to keep control pressures constant for a variety of supply air conditions. The unit will require a compressed air and a power source. Compressed air is commonly found in the service facility environment. Power for the unit will come directly from the brake flush machine, vehicle battery or vehicle cigarette lighter located in close proximity to the installed BFA. In the event that shop air is not available, for a specific application, the system can be adapted to operate pneumatically from tire pressure on the vehicle being serviced.

Testing of Invention—Time Versus Flow Tests

A test was performed to determine the effectiveness of the BFA. The unit was attached to a Phoenix Systems isolated brake flush machine. The test vehicle was a 1992 Chevy S-10 pickup with rear wheel ABS. The brake flush procedure took 27 minutes to flush ½ gallon of new brake fluid through the brake system. The Phoenix Systems brake flush machine is capable of isolating the wheel circuits which takes more time to flush the system as previously described.

Quality of Flush Tests

The next test was to determine the effectiveness of the flush using the Brake Flush Accelerator. A test, as described above, was performed using an all-wheel brake flush machine and FASCAR® Strip Dip brake fluid test strips. A control brake fluid with a know FASCAR rating of 100 was placed into the vehicle brake system. The vehicle was tested with Strip Dip®, demonstrating a FASCAR® rating of 100. The 12 minute brake flush was performed using ½ gallon of new brake fluid (FASCAR®=0) and the brake fluid was immediately tested in the master cylinder after the service, which resulted in a FASCAR® rating of 0. The vehicle was then driven and the brake pedal was depressed several times and a Strip Dips retest was performed, which resulted in a FASCAR® rating of approximately 50. The flush machine did not do a very good job in removing contamination from the brake system. This can be quite a problem if the customer brings his vehicle within a couple of weeks and a routine brake fluid test is performed and the technician recommends another brake flush. Some technicians claim the brake fluid test strip doesn't work, but the problem is the quality of the flush service performed.

Another sample of control brake fluid with a FASCAR® rating of 100 was placed back into the same vehicle. The vehicle was driven and the brake pedal depressed several times to make sure the control fluid was distributed throughout the system. A second flush was performed using the Phoenix Systems brake isolated flush machine and the Brake Flush Accelerator. The flush took approximately 7 minutes to flush a full ½ gallon of brake fluid through the system. That was almost twice as fast as the all wheel machine, which also pumped the unused fluid directly into waste. The Phoenix Systems machine and the BFA used a full ½ gallon of new brake fluid. The 7 minute flush also saved about 20 minutes over the standard isolated brake system flush. The brake fluid was immediately tested in the master cylinder after the service, which resulted in a FASCAR® rating of 0. The vehicle was then driven and the brake pedal was depressed several times and a Strip Dip® retest was performed, which resulted in a FASCAR® rating of approximately 10. It is difficult to be sure because only a very light pink was noticed on the FASCAR® test which was well below the 25 FASCAR® rating on the color chart. It is not possible to flush 100% of the contamination from the brake system, but a FASCAR® rating reduction from 100 to 10 is approximately a 95% reduction in contaminants because the FASCAR® rating scale is not linear. That is about as good as it gets.

The efficiency of the brake flush with the addition of the Brake Flush accelerator is attributed to the flushing of the low/no pressure area of the master cylinder and to sufficient fluid volume and pressure to remove contaminants from the system. The ability to isolate the circuits in the brake system ensures more equalized fluid flow and a more complete brake system flush.

Various changes in the details, steps and components that have been described may be made by those skilled in the art within the principles and scope of the invention herein illustrated and defined in the appended claims. Therefore, while the present invention has been shown and described herein in what is believed to be the most practical and preferred embodiments, it is recognized that departures can be made therefrom within the scope of the invention, which is not to be limited to the details disclosed herein but is to be accorded the full scope of the claims so as to embrace any and all equivalent processes and products.

1. A brake flush accelerator, comprising:
an upper portion including a length adjuster, said upper portion being connected to a steering wheel;
a control assembly including a pneumatic piston with an air control solenoid and an air-pressure regulator, said control assembly being connected to the upper portion;
a computer processing device electrically connected to the control assembly;
a lower portion connected to the pneumatic piston adapted to rest on a brake pedal; and
a guide connected to the control assembly and adapted to keep the lower portion in constant contact with the brake pedal;
wherein the computer processing device directs the pneumatic piston to press the lower portion against the brake pedal resulting in a depressing of the brake pedal.
